(19) United States
(12) Patent Application Publication
(10) Pub. No.: US 2014/0117171 A1
(43) Pub. Date: May 1, 2014

(54) CABLE HOLDER

(71) Applicant: ROLAND CORPORATION, Shizuoka (JP)

(72) Inventor: YOSHIAKI MORI, SHIZUOKA (JP)

(73) Assignee: ROLAND CORPORATION, Shizuoka (JP)

(21) Appl. No.: 14/029,810

(22) Filed: Sep. 18, 2013

(30) Foreign Application Priority Data
Oct. 31, 2012 (JP) 2012-241342

(51) Int. Cl. G10G 7/00

(52) U.S. Cl. CPC G10G 7/00
USPC 248/69; 248/49

(57) ABSTRACT

A cable holder which can securely hold cables is provided. The cable holder for holding cables comprises a base, a cable hole drilled into the base to hold the cables, a holding hole drilled into the base to hold holding objects, a first passage formed in an outer peripheral part of the base surrounding the holding hole to connect between outside and the holding hole, and a second passage formed between the holding hole and the cable hole to connect between the holding hole and the cable hole.

### CROSS-REFERENCE TO RELATED APPLICATIONS

This application claims the priority benefit of Japan application serial no. 2012-241342, filed on Oct. 31, 2012. The entirety of the above-mentioned patent application is hereby incorporated by reference herein and made a part of this specification.

### BACKGROUND OF THE INVENTION

1. Field of the Invention

The present invention relates to a cable holder. Particularly, the present invention relates to a cable holder which can securely hold cables.

2. Description of Related Art

In Patent Document 1, an electronic instrument system is described, in which various electronic percussion instruments, such as a cymbal pad, a tom pad, a hi-hat cymbal and a snare pad, are fixed to a pipe. In the pipe used in the electronic instrument system, a groove dented inward along the longitudinal direction is formed. Cables connected to each electronic percussion instrument are contained inside the groove.

However, there was a demand to securely hold the cables connected to each electronic percussion instrument in a different way from the way described in Patent Document 1.

### PRIOR ART REFERENCE

### Patent Document

Patent Document 1: Japan Patent Publication No. 2008-170644 Gazette

### SUMMARY OF THE INVENTION

The present invention has been made in order to solve the above-mentioned problem. The present invention seeks to provide a cable holder which can securely hold cables.

### Solution to the Problem and Effects of the Invention

According to one aspect of the present invention, a cable holder has the following effect. Cables are held by being introduced into a cable hole via a first passage, a holding hole and a second passage. The holding objects are held by being introduced into the holding hole via the first passage. Therefore, the cables held in the cable hole are prevented from popping out by the holding objects held in the holding hole. Accordingly, the cables can be securely held.

According to the other aspect of the present invention, the cable holder has the following effect. The cable holder includes at least one partition wall protruding from between the holding hole and the cable hole to one end side of the second passage. Therefore, due to the obstacle of the at least one partition wall, the cables held in the cable hole can be suppressed from passing through the second passage. Accordingly, the cables can be held more securely.

According to a further aspect of the present invention, the cable holder has the following effect. A first partition wall protrudes from between the holding hole and the cable hole to the one end of the second passage. A second partition wall protrudes from between the holding hole and the cable hole to the other end of the second passage. The first partition wall and the second partition wall protrude away from the holding hole towards the cable hole side to approach each other. Therefore, the cables held in the cable hole can be easily guided in a direction away from the second passage along the first and the second partition walls. Therefore, the cables can be suppressed from passing through the second passage. Accordingly, the cables can be held more securely.

According to a further aspect of the present invention, the cable holder has the following effect. A width of the second passage is configured to be narrower than a width of the first passage. Hereby, the holding objects held in the holding hole can be suppressed from being inserted into the cable hole via the second passage. Therefore, the cables held in the cable hole can be prevented from popping out by the holding objects held in the holding hole. Accordingly, the cables can be held more securely.

According to a further aspect of the present invention, the cable holder has the following effect. The cable hole is larger than the holding hole. Therefore, comparing with a case in which the cable hole is smaller than the holding hole, the first and the second passages can be made difficult to open.

According to a further aspect of the present invention, the cable holder has the following effect. Among an electronic percussion instrument set having a frame, one or more electronic percussion instrument being fixed to the frame, and the cables being connected to the electronic percussion instrument, an attaching part is attached to the frame. Therefore, by making the cable hole hold the cables connected to the electronic percussion instrument, a performance being disturbed due to the cables can be prevented. In addition, a tool for fixing the electronic percussion instrument to the frame can be treated as the holding objects, and both of the tool and the cables can be securely held.

### BRIEF DESCRIPTION OF DRAWINGS

FIG. 1 is a perspective view showing an electronic drum set to which cable holders are attached.

FIG. 2A is a plan view showing a connecting cable.

FIG. 2B is a top view of a drum key.

FIG. 3A is a plan view of the cable holder.

FIG. 3B is a cross-sectional view of the cable holder.

FIGS. 4A-4C are diagrams to describe how to use the cable holder.

FIG. 5A is a plan view showing another embodiment of the cable holder.

FIG. 5B is a plan view showing another embodiment of the cable holder.

FIG. 5C is a plan view showing another embodiment of the cable holder.

FIG. 5D is a plan view showing another embodiment of the cable holder.

FIG. 5E is a plan view showing another embodiment of the cable holder.

FIG. 5F is a plan view showing another embodiment of the cable holder.

FIG. 6A is a perspective view showing another embodiment of an object held by a tool hole.

FIG. 6B is a perspective view showing another embodiment of an object held by the tool hole.

### DESCRIPTION OF EMBODIMENTS

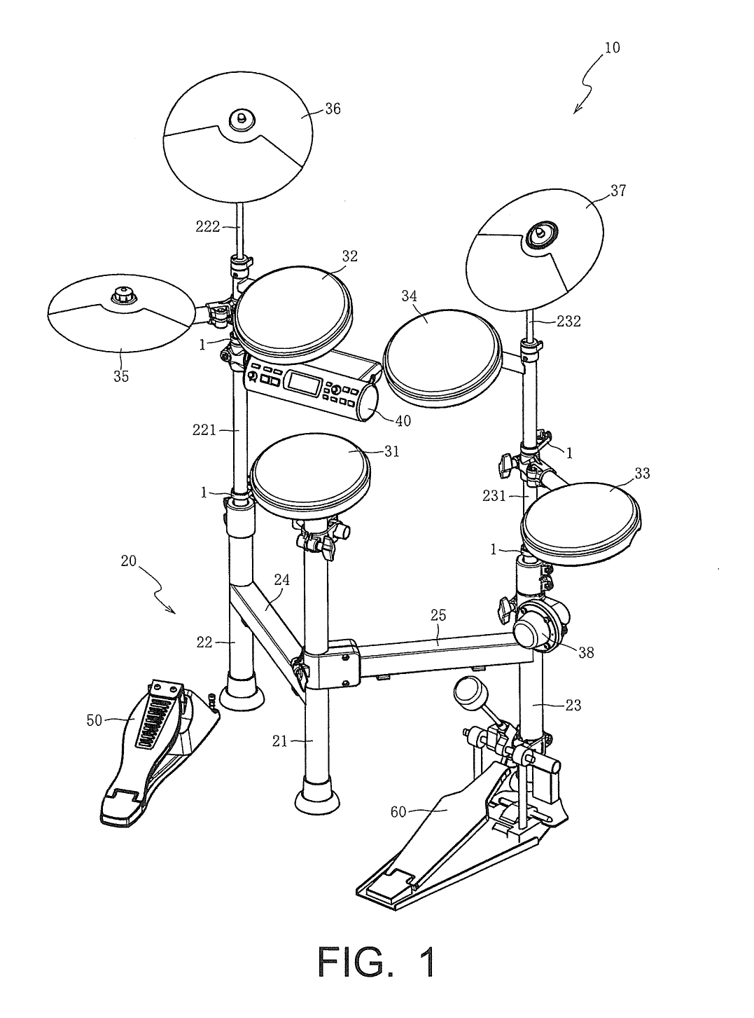

Preferred embodiments of the present invention are described below referring to the accompanying drawings. First, an electronic drum set 10 is described, in which cable holders 1 are attached. FIG. 1 is a perspective view showing an electronic drum set 10.

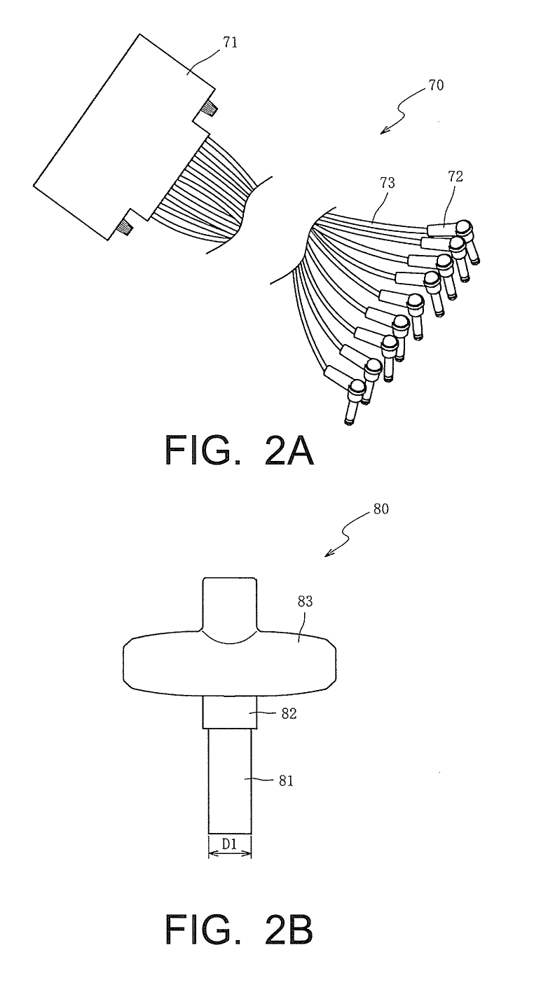

The electronic drum set 10 senses a vibration caused by hitting various pads 31-38. In addition, the electronic drum set 10 transmits an electrical signal corresponding to the sensed vibration to a sound source 40 via a connecting cable 70 (see FIG. 2A). Moreover, the electronic drum set 10 outputs electronic sounds corresponding to the electrical signal transmitted to the sound source 40.

The electronic drum set 10 is mainly composed of a stand 20, the various pads, the sound source 40, a hi-hat control pedal 50, and a kick pedal 60. The various pads include a snare drum 31, a first, a second and a third toms 32, 33 and 34, a hi-hat 35, a crash cymbal 36, a ride cymbal 37, and a kick pad 38.

The stand 20 supports the various pads 31-38 and the like. The stand 20 is composed of a center post 21, a left post 22, a right post 23, a left transverse frame 24, and a right transverse frame 25. The left post 22 is disposed on the left back of the center post 21. The right post 23 is disposed on the right back of the center post 21. The left transverse frame 24 connects the center post 21 and the left post 22. The right transverse frame 25 connects the center post 21 and the right post 23.

The snare drum 31 is attached to the upper end of the center post 21. The hi-hat control pedal 50 is disposed on the base of the left post 22. A left vertical pipe 221 is connected to the upper side of the left post 22. Three transverse pipes extending to the sides are connected to the left vertical pipe 221. The sound source 40, the hi-hat 35 and the first tom 32 are attached to each of the transverse pipes. A left vertical rod 222 is connected to the upper side of the left vertical pipe 221. The crash cymbal 36 is attached to the upper end of a left vertical rod 222.

The kick pedal 60 is disposed on the base of the right post 23. The kick pad 38 is attached in the middle of the right post 23. A right vertical pipe 231 is connected to the upper side of the right post 23. Two transverse pipes extending to the sides are connected to the right vertical pipe 231. The second and the third toms 33 and 34 are attached to each of the transverse pipes. A right vertical rod 232 is connected to the upper side of the right vertical pipe 231. The ride cymbal 37 is attached to the upper end of the right vertical rod 232. Regarding the cable holders 1 in the present invention, a total of four cable holders, which are upper and lower cable holders to the left vertical pipe 221 and upper and lower cable holders to the right vertical pipe 231, are attached.

FIG. 2A is a plan view showing a connecting cable 70. The connecting cable 70 is connected to the electronic drum set 10. The connecting cable 70 is composed of a first terminal 71, a total of nine second terminals 72, and nine cables 73. The first terminal 71 is connected to the sound source 40. The nine second terminals 72 are connected to each of the pads 31-38 and the hi-hat control pedal 50, respectively. The nine cables 73 connect the first terminal 71 at one side and respectively connect the nine second terminals 72 at the other side.

Here, referring to FIG. 1, a case is described in which the connecting cable 70 is connected to the electronic drum set. In FIG. 1, the illustration of the connecting cable 70 is omitted. The first terminal 71 of the connecting cable 70 is connected to the sound source 40, and the nine cables 73 are passed through the cable holder 1 attached to the upper side of the left vertical pipe 221, wherein three of the second terminals 72 connected to three of the cables 73 are connected to the hi-hat 35, the first tom 32, and the crash cymbal 36 respectively.

The other six of the cables 73 are passed through the cable holder 1 attached to the lower side of the left vertical pipe 221. The second terminal 72 connected to three of the other six cables 73 are connected to the hi-hat control pedal 50, the snare drum 31 and the kick pad 38 respectively.

The rest of the other six cables 73 are passed through each of the two cable holders 1 attached to the right vertical pipe 231. The second terminals 72 connected to the rest of the cables 73 are connected to the second tom 33, the third tom 34 and the ride cymbal 37 respectively. In this way, each of the pads 31-38 and the hi-hat control pedal 50 are connected to the sound source 40 via the connecting cable 70.

FIG. 2B is a top view of a drum key 80. The drum key 80 is a specialized tool used to fasten and loosen bolts that are used on the electronic drum set 10. The bolts are, for example, used to fasten the first to the third toms 32-34 to the transverse pipe, and are used to fasten the transverse pipe, to which the sound source 40 or the hi-hat 35 is attached, to the left vertical pipe 221.

The drum key 80 is composed of a tip part 81, a main body part 82 and a handle part 83. The handle part 83 is extended from the middle of the main body part 82 to the sides. The tip part 81 is formed in a columnar shape with an outer diameter D1. A fitting hole fitting to the bolts used in the electronic drum set 10 is formed inside the tip part 81. Therefore, by making the fitting hole and the bolts fit and rotating the drum key 80 to a clockwise direction or a counterclockwise direction by holding the handle part 83, the bolts can be fastened and loosened. Accordingly, slopes of the first to third toms 32-34, the sound source 40, and the hi-hat 35 can be adjusted to the desired angles.

Thus, the drum key 80 is sometimes used on the electronic drum set 10 but the drum key 80 may be easy to lose because it is small and separated from the electronic drum set 10. On the other hand, providing an extra drum key holder especially for the drum key 80 may increase costs. In contrast, the cable holder 1 can securely hold the cables 73 and the drum key 80, so that the drum key 80 can be suppressed from being lost without increasing the manufacturing cost.

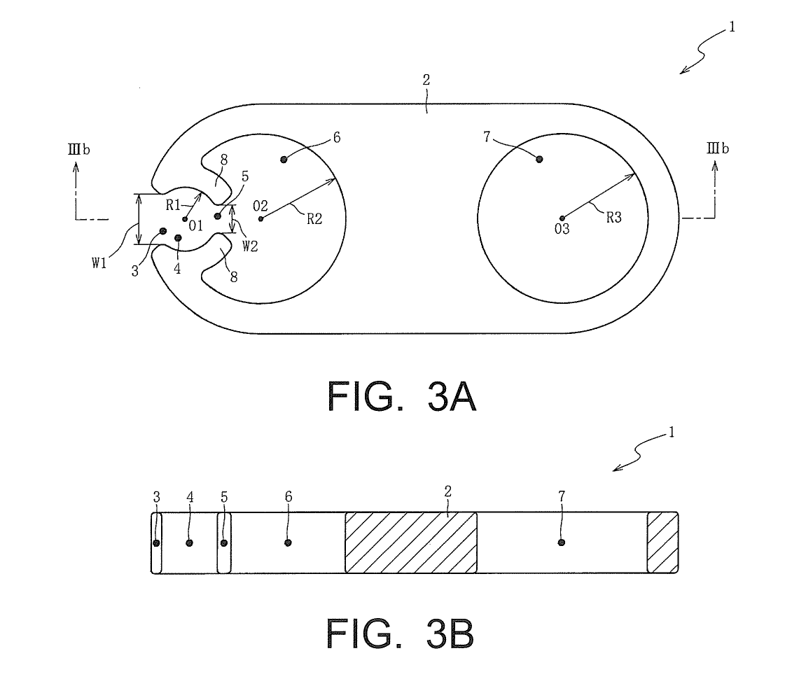

FIG. 3A is a plan view of the cable holder 1, and FIG. 3B is a cross-sectional view of the cable holder 1 taken along line IIIb-IIIb. The cable holder 1 is configured by drilling the first passage 1, the tool hole 4, the second passage 5, the cable hole 6, and the attaching hole 7 into a base 2 in an elliptical shape in plan view.

In addition, the cable holder 1 has a predetermined elasticity. For example, the cable holder 1 is composed of materials such as resins, such as ABS resin, PP (polypropylene), PA (polyamide), PC (polycarbonate), or rubber. Hereby, taking in and out of the cables 73 and the drum key 80 can be facilitated.

The first passage 3 is a passage for taking the cables 73 and the drum key 80 in and out of the base 2. The first passage 3 is configured by dividing a part of an outer peripheral part of the base 2. A width W1 of the first passage 3 is configured to be slightly smaller than the outer diameter D1 of the tip part of the drum key 80. When the tip part of the drum key 80 is pressed against the first passage 3, the first passage 3 is slightly extended and the drum key 80 is introduced into the tool hole 4. Since the outer diameters of each of the cables 73 are smaller than the width W1 of the first passage 3, each of the cables 73 are also introduced into the tool hole 4 via the first passage 3.

The tool hole 4 is a hole for holding the drum key 80. The tool hole 4 is connected to the first passage 3 and formed in a circular shape with a center O1 and a radius R1. The diameter of the tool hole 4 is substantially equal to the outer diameter D1 of the tip part of the drum key 80. In addition, the diameter of the tool hole 4 is configured to be smaller than the outer diameter of the main body part of the drum key 80. Therefore, the drum key 80 introduced into the tool hole 4 via the first passage 3 is held in the tool hole 4 in a state in which the periphery of the tip part 81 is surrounded by the tool hole 4 and the main body part 82 is placed on the base 2.

The second passage 5 is a passage for taking the cables 73 in and out between the tool hole 4 and the cable hole 6. The second passage 5 is formed between tips of two partition walls 8, 8. A width W2 of the second passage 5 is smaller than the width W1 of the first passage 3, and is configured to be a size which can restrict passing of the tip part of the drum key 80 through the second passage 5. Therefore, the drum key 80 can be suppressed from entering into the cable hole 6 via the second passage 5.

Moreover, the width W2 of the second passage 5 is configured to be a size which at least one cable 73 can pass through simultaneously. When the drum key 80 is held in the tool hole 4, the second passage 5 becomes a state of being closed by the drum key 80. Therefore, the cables 73 held in the cable hole 6 can be prevented from popping out via the second passage 5.

The cable hole 6 is a hole for holding the cables 73. The cable hole 6 is communicated to the second passage 5 and fanned in a shape which is connected in a circular shape taking between the tip parts of two partition walls 8, 8 as a center O2 and a radius R2. The cable hole 6 is larger than the tool hole 4. Moreover, the cable hole 6 is configured to be a size which still has enough space even if the nine cables are introduced.

Therefore, even if the cables 73 introduced into the cable hole 6 are shaken, the shaking can be absorbed inside the cable hole 6. That is, the cables 73 can be prevented from popping out from the second passage 5. In addition, the opening area of the cable hole 6 is configured to be larger than that of the tool hole 4. Therefore, compared with the opposite case, the first passage 3 and the second passage 5 become difficult to extend. This way, the drum key 80 and the cable 73 can be prevented from popping out.

Moreover, the cable hole 6 is separated from the tool hole 4 by the two partition walls 8, 8. The two partition walls 8, 8 are protruded in a circular arc shape so as to approach each other from the tool hole 4 to the cable hole 6. Therefore, the cables 73 held in the cable hole 6 can be easily guided in a direction away from the second passage 5 along the two partition walls 8, 8. Accordingly, the cables 73 are more assuredly prevented from popping out from the second passage 5.

The attaching hole 7 is a hole for passing the left vertical pipe 221 and the right vertical pipe 231 through. The attaching hole 7 is formed in a circular shape with a center O3 and a radius R3. The attaching hole 7 is configured to be slightly larger than the outer diameter of the left vertical pipe 221 and the outer diameter of the right vertical pipe 231. Therefore, by passing the left vertical pipe 221 and the right vertical pipe 231 through the attaching hole 7, the cable holder 1 itself can be attached to the left vertical pipe 221 and the right vertical pipe 231.

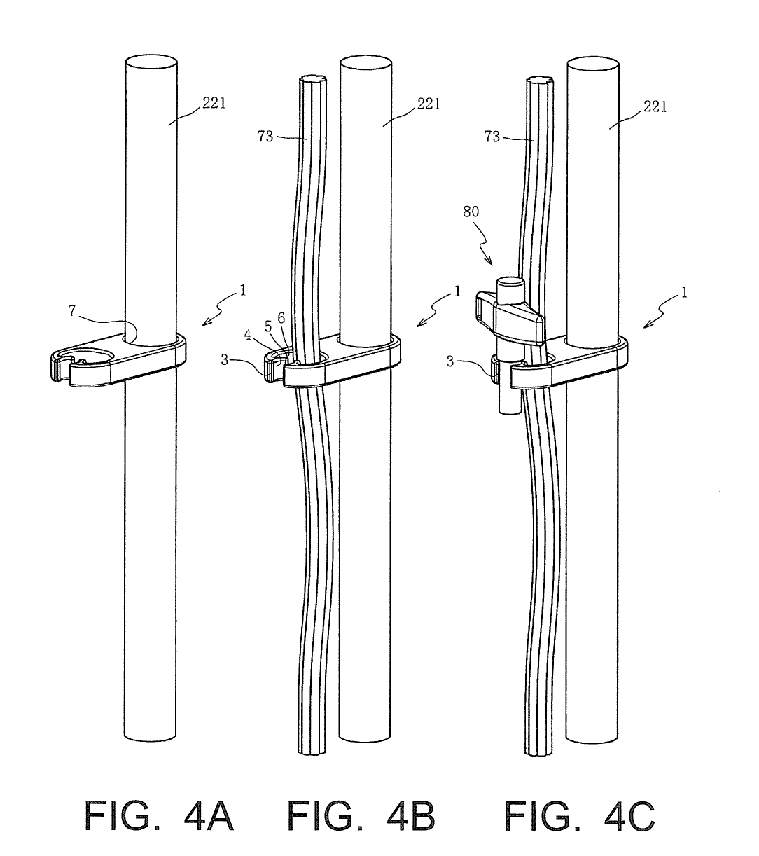

FIG. 4A, FIG. 4B and FIG. 4C are diagrams to describe how to use the cable holder 1. As shown in FIG. 4A, the cable holder 1 passes the left vertical pipe 221 (or the right vertical pipe 231, the same applies hereafter) through the attaching hole 7 to be attached to the left vertical pipe 221. Next, as shown in FIG. 4B, the cables 73 held in the cable hole 6 are held by being introduced into the cable hole 6 via the first passage 3, the tool hole 4 and the second passage 5. In FIG. 4B, a state of bundling a plurality of the cables 73 is illustrated. In addition, as shown in FIG. 4C, the drum key 80 is held by being introduced into the tool hole 4 via the first passage 3.

This way, the cable holder 1 is attached to the left vertical pipe 221, and the cables 73 are held by the cable hole 6 and the drum key 80 is held by the tool hole 4. Hereby, the second passage 5 is closed by the drum key 80, therefore, the cables 73 held in the cable hole 6 can be prevented from popping out via the second passage 5. Accordingly, the cables 73 can be securely held. In addition, since the drum key 80 can be held in the tool hole 4, an extra holder especially for the drum key 80 does not need to be prepared. Therefore, the drum key 80 can be suppressed from losing without increasing the cost.

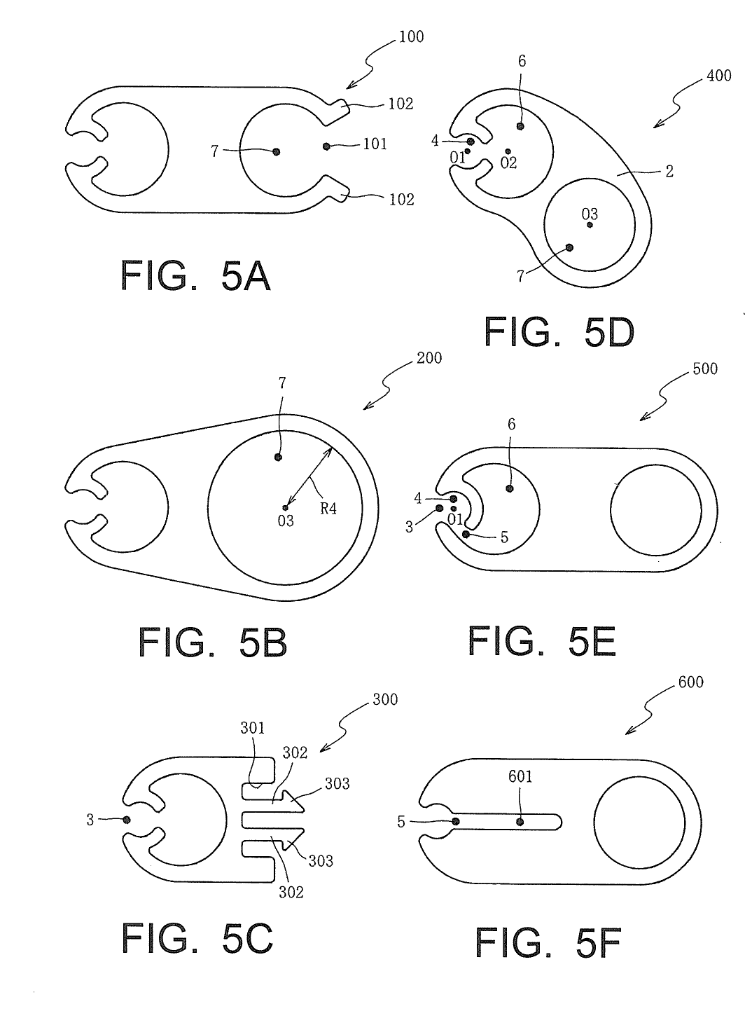

FIG. 5A, FIG. 5B, FIG. 5C, FIG. 5D, FIG. 5E and FIG. 5F are plan views showing other embodiments of the above-mentioned cable holders 1. It is noted that the same reference numerals are used for the same structure as the above-mentioned cable holder 1, or the description thereof will be omitted without using reference numerals. First, referring to FIG. 5A-FIG. 5D, cable holders 100, 200, 300 and 400 in a first, second, third and fourth embodiments are described. Configurations related to the attaching hole 7 of the cable holders 100, 200, 300 and 400 are modified for the above-mentioned cable holder 1.

As for the cable holder 100 showed in FIG. 5A, a third passage 101 connecting the outside and the attaching hole 7 is formed in the outer peripheral portion of the base 2. A width of the third passage 101 is configured to be slightly smaller than the outer diameter of the left vertical pipe 221. In addition, guides 102, 102 protruding to a direction away from each other toward the outside from the end part of the base 2 interposing the third passage 101 therebetween are disposed on the cable holder 100.

Therefore, by pressing the guides 102, 102 against the left vertical pipe 221 from the side and pressing the cable holder 100 into the left vertical pipe 221, the cable holder 100 can be attached to the left vertical pipe 221. In addition, by pulling the cable holder 100 out from the side, the cable holder 100 can be removed. Therefore, the cable holder 100 can be easier to attach and detach than the above-mentioned cable holder 1.

As for the cable holder 200 shown in FIG. 5B, the attaching hole 7 is larger than the above-mentioned cable holder 1. The attaching hole 7 on the cable holder 200 is configured with a radius R4. The radius R4 is configured to be slightly larger than the outer diameters of the left post 22 and the right post 23. Therefore, the cable holder 200 can be attached to the left post 22 and the right post 23. In addition, by using both of the cable holder 1 and the cable holder 200, the degree of freedom of an interval passing the cables 73 through can be improved.

As for the cable holder 300 shown in FIG. 5C, a recess part 301 and two protrusion walls 302, 302 are formed instead of the attaching hole 7. The recess part 301 is recessed toward the first passage 3, on a side of the base 2 opposite to the first passage 3. The protrusion walls 302 protrude from a bottom of the recess part 301, towards a side away from the first passage 3. A gap is formed between two protrusion walls 302, 302. Engaging parts 303, 303 protruding to the opposite side of the gap are disposed on the tip side of the protrusion walls 302, 302. In addition, the engaging parts 303, 303 are sloped to approach each other toward the tips.

On the other hand, an insertion slot to fit to the engaging parts 303, 303 is opened on the left vertical pipe 221 to which the cable holder 300 is attached. By inserting the tips of the protrusion walls 302, 302 into the insertion slot, the cable holder 300 is attached to the left vertical pipe 221. That is, the engaging parts 303, 303 are inserted while being pressed inward by the edge part of the insertion slot, and then the protrusion walls 302, 302 are attached by engaging with the edge part of the insertion slot after returning to the original condition. Therefore, the cable holder 300 can be attached to the left vertical pipe 221 more easily than the above-mentioned cable holder 1.

As for the cable holder 400 shown in FIG. 5D, the position of the attaching hole 7 is modified. In the above-mentioned cable holder 1, the center O1 of the tool hole 4, the center O2 of the cable hole 6, and the center O3 of the attaching hole 7 are located on the same straight line. However, in the cable holder 400, the center O3 of the attaching hole 7 is foamed at a position shifted from the line connecting the center O1 of the tool hole 4 and the center O2 of the cable hole 6. Hereby, in the cable holder 400, the length of the base 2 can be shortened. Therefore, the amount of protrusion of the cable holder 400 from the left vertical pipe 221 can be decreased.

Next, referring to FIG. 5E, the cable holder 500 in the fifth embodiment is described. Compared with the above-mentioned cable holder 1, the location of the second passage 5 is modified in the cable holder 500. In the cable holder 1, the center of the first passage 3, the center of the tool hole 4 and the center of the second passage 5, are located on the same straight line. However, in the cable holder 500, the center of the second passage 5 is formed at a position shifted from the straight line connecting the center of the first passage 3 and the center O1 of the tool hole 4.

Thereby, in the cable holder 500, a force for pressing the drum key 80 held in the tool hole 4 by the cables 73 held in the cable hole 6 toward the first passage 3 can be further suppressed than a case of the cable holder 1. Therefore, the drum key 80 can be suppressed from popping out from the tool hole 4. That is, the cables 73 can also be prevented from popping out.

Next, referring to FIG. 5F, the cable holder 600 in the sixth embodiment is described. Compared with the above-mentioned cable holder 1, the shape of the cable hole 6 is modified in the cable holder 600. In the cable holder 600, a cable hole 601 is formed in a long-hole shape communicating the cable hole 601 with the second passage 5. In the cable holder 600, there is no partition wall that is included in the cable holder 1. Accordingly, a possibility that the cables 73 may pop out becomes higher than the cable holder 1. However, there is no partition wall 8 to be broken. Therefore, the cable holder 600 can be prevented from being useless by the breaking down of the partition wall 8.

The present invention was described with respect to the embodiments but the present invention is not limited to the above-mentioned embodiments. It should be apparent to those skilled in the art that various changes and modifications can be made within the spirit and scope of the invention.

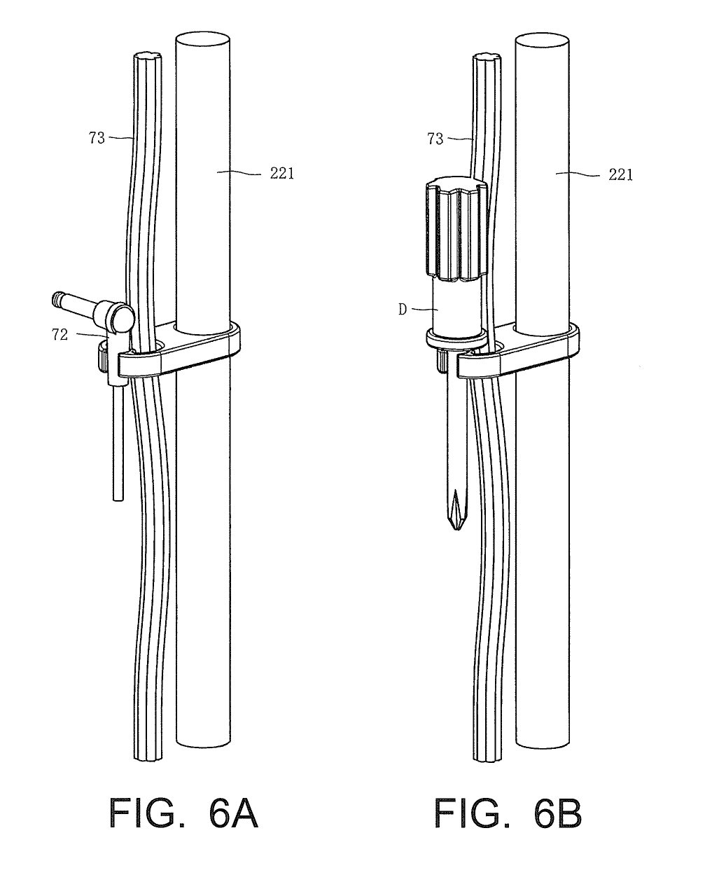

In the above-mentioned embodiments, a case has been described in which the drum key 80 is held by the tool hole 4. However, the holding objects held in the tool hole 4 are not limited to the drum key 80. At least, it only needs to be able to be held by the tool hole 4, more preferably to be able to close the second passage 5. For example, as shown in FIG. 6A, the second terminal 72 (for example, the second terminal 72 connected to the hi-hat control pedal 50) may be held. In addition, as shown in FIG. 6B, a tool, such as a generic driver D, may be held. Moreover, a peculiar part to be held in the tool hole 4 may be provided.

In the above-mentioned embodiments, a case has been described in which the cable holder 1 is attached to the left vertical pipe 221 by passing the left vertical pipe 221 through the attaching hole 7. However, the way to attach the cable holder 1 to the left vertical pipe 221 is not limited thereto. It may be attached by disposing a male screw on one of the cable holder 1 and the left vertical pipe 221, and a female screw on the other one. In addition, it may be attached by attaching the cable holder to a clamp and fastening the left vertical pipe 221 by the clamp. Moreover, it may be attached by using a double-sided tape, a hook-and-loop fastener or an adhesive.

In the above-mentioned embodiment, one first passage 3 and one holding hole 4 are introduced. However, the number of the first passage 3 and the holding hole 4 are not limited to one, and may be more than one. For example, in addition to the holding hole for the drum key 80, the holding hole for the second terminal 72 shown in FIG. 6A and the holding hole for the driver D shown in FIG. 6B may be disposed. In this case, the drum key 80, the cables 73, the second terminal 72 and the driver D can be held by the cable holder 1. In addition, in this case, the hole for holding the second terminal 72 and the hole for holding the driver D may be communicated with the cable hole 6.

In the above-mentioned embodiment, a case has been described in which a total of four cable holders, upper and lower cable holders to the left vertical pipe 221 and upper and lower cable holders to the right vertical pipe 231, are attached, but not limited thereto. The location to attach the cable holder 1 can be optional. The location to attach the cable holder may be, for example, on the center post 21, the left post 22 or the right post 23. Moreover, the location to attach the cable holder may be on a transverse arm which is connected to the left vertical pipe 221 or right vertical pipe 231 and is connected to various pads. In addition, the attaching number is also optional, and it only needs to be one or more.

What is claimed is:

1. A cable holder for holding cables, comprising,
a base;
a cable hole, drilled into the base to hold the cables;
a holding hole, drilled into the base to hold at least one holding object;
a first passage, formed in an outer peripheral part of the base surrounding the holding hole to connect between an outside and the holding hole; and
a second passage, formed between the holding hole and the cable hole to connect between the holding hole and the cable hole.

2. The cable holder as claimed in claim 1, further comprising at least one partition wall protruding from between the holding hole and the cable hole to one end side of the second passage.

3. The cable holder as claimed in claim 2, wherein the at least one partition wall comprises a first partition wall protruding from between the holding hole and the cable hole to the one end side of the second passage and a second partition wall protruding from between the holding hole and the cable hole to another end side of the second passage,
wherein the first partition wall and the second partition wall are protruded away from the holding hole to approach each other toward the cable hole.

4. The cable holder as claimed in claim 3, wherein a width of the second passage is configured to be narrower than a width of the first passage.

5. The cable holder as claimed in claim 4, wherein the cable hole is configured to be larger than the holding hole.

6. The cable holder as claimed in claim 5, further comprising an attaching part which is attached to a frame of an electronic percussion instrument set, wherein the electronic percussion instrument set comprises the frame, at least one electronic percussion instrument fixed to the frame, and the cables connected to the electronic percussion instrument.

7. The cable holder as claimed in claim 1, wherein a width of the second passage is configured to be narrower than a width of the first passage.

8. The cable holder as claimed in claim 7, wherein the cable hole is configured to be larger than the holding hole.

9. The cable holder as claimed in claim 8, further comprising an attaching part attached to a frame of an electronic percussion instrument set, wherein the electronic percussion instrument set comprises the frame, at least one electronic percussion instrument fixed to the frame, and the cables connected to the electronic percussion instrument.

10. The cable holder as claimed in claim 1, wherein the cable hole is configured to be larger than the holding hole.

11. The cable holder as claimed in claim 10, further comprising an attaching part attached to a frame of an electronic percussion instrument set, wherein at least one electronic percussion instrument is fixed to the frame and the cables connected to the electronic percussion instrument.

12. The cable holder as claimed in claim 1, further comprising an attaching part attached to a frame of an electronic percussion instrument set, wherein at least one electronic percussion instrument is fixed to the frame and the cables connected to the electronic percussion instrument.

13. The cable holder as claimed in claim 1, wherein a center of the first passage, a center of the holding hole and a center of the second passage are located on a same straight line.

14. The cable holder as claimed in claim 1, wherein a center of the first passage, a center of the holding hole and a center of the second passage are not located on a same straight line.

15. The cable holder as claimed in claim 1, wherein the cable hole is formed in an approximate circular shape.

16. The cable holder as claimed in claim 1, wherein the cable hole is formed in a long-hole shape.

17. The cable holder as claimed in claim 12, wherein an attaching hole is drilled into the attaching part and a center of the holding hole, and a center of the cable hole and a center of the attaching hole are located on a same straight line.

18. The cable holder as claimed in claim 12, wherein an attaching hole is drilled into the attaching part and a center of the holding hole, and a center of the cable hole and a center of the attaching hole are not located on a same straight line.

19. The cable holder as claimed in claim 1, composed of a material having a predetermined elasticity.
